(19) United States
(12) Patent Application Publication
(10) Pub. No.: US 2006/0107116 A1
(43) Pub. Date: May 18, 2006

(54) System and method for reestablishing lockstep for a processor module for which loss of lockstep is detected

(76) Inventors: Scott L. Michaelis, Plano, TX (US); Sylvia K. Myer, Fort Collins, CO (US); William B. McHardy, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/973,003

(22) Filed: Oct. 25, 2004

(51) Int. Cl. G06F 11/00

(52) U.S. Cl. 714/25

(57) ABSTRACT

According to one embodiment, a method comprises, responsive to detection of loss of lockstep (LOL) for a processor module in a system, firmware requesting an operating system to idle the processor module. The method further comprises the operating system idling the processor module and returning control of the processor module to the firmware. According to one embodiment, a method comprises an operating system idling a processor module for which A loss of lockstep (LOL) is detected, and system firmware receiving control of the processor module. The method further comprises the system firmware determining whether a LOL was detected for the processor module, and if determined that LOL was detected for the processor module, the system firmware resetting the processor module to reestablish lockstep for the processor module.

### CROSS-REFERENCE TO RELATED APPLICATIONS

The present application is related to the following concurrently filed and commonly assigned U.S. patent applications Ser. No. ______ [Attorney Docket No. 200404944-1] titled “SYSTEM AND METHOD FOR ESTABLISHING A SPARE PROCESSOR FOR RECOVERING FROM LOSS OF LOCKSTEP IN A BOOT PROCESSOR”; Ser. No. ______ [Attorney Docket No. 200404943-1] titled “SYSTEM AND METHOD FOR CONFIGURING LOCKSTEP MODE OF A PROCESSOR MODULE”; Ser. No. ______ [Attorney Docket No. 200404941-1] titled “SYSTEM AND METHOD FOR PROVIDING FIRMWARE RECOVERABLE LOCKSTEP PROTECTION”; Ser. No. ______ [Attorney Docket No. 200404973-1 titled “SYSTEM AND METHOD FOR SWITCHING THE ROLE OF BOOT PROCESSOR TO A SPARE PROCESSOR RESPONSIVE TO DETECTION OF LOSS OF LOCKSTEP IN A BOOT PROCESSOR”; Ser. No. ______ [Attorney Docket No. 200404946-1] titled “SYSTEM AND METHOD FOR USING INFORMATION RELATING TO A DETECTED LOSS OF LOCKSTEP FOR DETERMINING A RESPONSIVE ACTION”; Ser. No. ______ [Attorney Docket No. 200404970-1] titled “SYSTEM AND METHOD FOR SYSTEM FIRMWARE CAUSING AN OPERATING SYSTEM TO IDLE A PROCESSOR”; Ser. No. ______ [Attorney Docket No. 200404972-1] titled “SYSTEM AND METHOD FOR REINTRODUCING A PROCESSOR MODULE TO AN OPERATING SYSTEM AFTER LOCKSTEP RECOVERY”; and Ser. No. ______ [Attorney Docket No. 200404974-1] titled “SYSTEM AND METHOD FOR MAINTAINING IN A MULTI-PROCESSOR SYSTEM A SPARE PROCESSOR THAT IS IN LOCKSTEP FOR USE IN RECOVERING FROM LOSS OF LOCKSTEP FOR ANOTHER PROCESSOR”, the disclosures of which are hereby incorporated herein by reference.

### DESCRIPTION OF RELATED ART

Silent Data Corruption (“SDC”) is a difficult problem in the computing industry. In general, SDC refers to data that is corrupt, but which the system does not detect as being corrupt. SDCs primarily occur due to one of two factors: a) a broken hardware unit or b) a “cosmic” event that causes values to change somewhere in the system. Broken hardware means that a “trusted” piece of hardware is silently giving wrong answers. For example, the arithmetic unit in a processor is instructed to add 1+1 and it returns the incorrect answer 3 instead of the correct answer 2. An example of a cosmic event is when a charged particle (e.g., alpha particle or cosmic ray) strikes a region of a computing system and causes some bits to change value (e.g., from a 0 to a 1 or from a 1 to a 0).

Numerous techniques have been developed for detecting SDC to prevent the SDC from remaining “silent” or “undetected” within a system, as well as preventing such SDC from propagating through the system. Examples of these techniques include parity-based mechanisms and error correcting codes (ECCs) on buses and memory locations, as well as checksums and/or cyclic redundancy checks (CRC) over regions of memory. Parity-based mechanisms are often employed in processors, wherein a parity bit is associated with each block of data when it is stored. The parity bit is set to one or zero according to whether there is an odd or even number of ones in the data block. When the data block is read out of its storage location, the number of ones in the block is compared with the parity bit. A discrepancy between the values indicates that the data block has been corrupted. ECCs are parity-based mechanisms that track additional information for each data block. The additional information allows the corrupted bit(s) to be identified and corrected.

Parity/ECC mechanisms have been employed extensively for caches, memories, and similar data storage arrays. In the remaining circuitry on a processor, such as data paths, control logic, execution logic, and registers (the “execution core”), it is more difficult to apply parity/ECC mechanisms for SDC detection. Thus, there is typically some unprotected area on a processor in which data corruption may occur and the parity/ECC mechanisms do not prevent the corrupted data from actually making it out onto the system bus. One approach to SDC detection in an execution core (or other unprotected area of the processor chip) is to employ “lockstep processing.” Generally, in lockstep processing two processors are paired together, and the two processors perform exactly the same operations and the results are compared (e.g., with an XOR gate). If there is ever a discrepancy between the results of the lockstep processors, an error is signaled. The odds of two processors experiencing the exact same error at the exact same moment (e.g., due to a cosmic event occurring in both processors at exactly the same time or due to a mechanical failure occurring in each processor at exactly the same time) is nearly zero.

A pair of lockstep processors may, from time to time, lose their lockstep. “Loss of lockstep” (or “LOL”) is used broadly herein to refer to any error in the pair of lockstep processors. One example of LOL is detection of data corruption (e.g., data cache error) in one of the processors by a parity-based mechanism and/or ECC mechanism. Another example of LOL is detection of the output of the paired processors not matching, which is referred to herein as a “lockstep mismatch.” It should be recognized that in some cases the data in the cache of a processor may become corrupt (e.g., due to a cosmic event), which once detected (e.g., by a parity-based mechanism or ECC mechanism of the processor) results in LOL. Of course, unless such corrupt data is acted upon by the processor, the output of that processor will not fail to match the output of its paired processor and thus a “lockstep mismatch” will not occur. For example, suppose that a value of “1” is stored to first location of cache in each of a pair of lockstep processors and a value of “1” is also stored to a second location of cache in each of the pair of lockstep processors. Further suppose that a cosmic event occurs for a first one of the processors, resulting in the first location of its cache being changed from “1” to “0”, and thus corrupted. This data corruption in the first processor is a LOL for the pair. An error detection mechanism of this first processor may detect the data corruption, thus detecting the LOL. If the processors are instructed to act on the data of their first cache locations, then a lockstep mismatch will occur as the output of each of the processors will not match. For instance, if the processors each add the data stored to the first location of their respective cache with the data stored to the second location of their respective cache, the first processor (having the corrupt data) will output a result of “1” (0+1=1) while the second processor outputs a result of “2” (1+1=2), and thus their respective outputs will not match.

By employing such techniques as parity-based error detection mechanisms and output comparisons for lockstep paired processors, SDC detection can be enhanced such that practically no SDC occurring in a processor goes undetected (and thus such SDC does not remain “silent”) but instead results in detection of LOL. However, the issue then becomes how best for the system to respond to detected LOL. The traditional response to detected LOL has been to crash the system to ensure that the detected error is not propagated through the system. That is, LOL in one pair of lockstep processors in a system halts processing of the system even if other processors that have not encountered an error are present in the system. However, with the increased desire for many systems to maintain high availability, crashing the system each time LOL is detected is not an attractive proposition. This is particularly unattractive for large systems having many processors because cosmic events typically occur more frequently as the processor count goes up, which would result in much more frequent system crashes in those large systems. High availability is a major desire for many customers having large, multi-processor systems, and thus having their system crash every few weeks is not an attractive option. Of course, permitting corrupt data to propagate through the system is also not a viable option.

Prior solutions attempting to resolve at least some detected SDCs without requiring the system to be crashed have been Operating System (“OS”) centric. That is, in certain solutions the OS has been implemented in a manner to recover from a detected LOL without necessarily crashing the system. This OS-centric type of solution requires a lot of processor and platform specific knowledge to be embedded in the OS, and thus requires that the OS provider maintain the OS up-to-date as changes occur in later versions of the processors and platforms in which the OS is to be used. This is such a large burden that most commonly used OSs do not support lockstep recovery.

Certain solutions have attempted to recover from a LOL without involving the OS in such recovery procedure. For instance, in one technique upon LOL being detected, firmware is used to save the state of one of the processors in a lockstep pair (the processor that is considered “good”) to memory, and then both processors of the pair are reset and reinitialized. Thereafter, the state is copied from the memory to each of the processors in the lockstep pair. This technique makes the processors unavailable for an amount of time without the OS having any knowledge regarding this unavailability, and if the amount of time required for recovery is too long, the system may crash. That is, typically, if a processor is unresponsive for X amount of time, the OS will assume that the processor is hung and will crashdump the system so that the problem can be diagnosed. Further, in the event that a processor in the pair cannot be reset and reinitialized (e.g., the processor has a physical problem and fails to pass its self-test), this technique results in crashing the system.

### BRIEF SUMMARY OF THE INVENTION

According to one embodiment, a method for reestablishing lockstep for a processor module for which loss of lockstep is detected is provided. The method comprises an operating system idling a processor module for which loss of lockstep (LOL) is detected, and system firmware receiving control of the processor module. The method further comprises the system firmware determining whether a LOL was detected for the processor module, and if determined that LOL was detected for the processor module, the system firmware resetting the processor module to reestablish lockstep for the processor module.

According to one embodiment, a method comprises detecting loss of lockstep for a lockstep pair of processors. The method further comprises requesting, by system firmware, an operating system to idle the lockstep pair of processors, and idling, by the operating system, the lockstep pair of processors.

According to one embodiment, a method comprises, responsive to detection of loss of lockstep (LOL) for a processor module in a system, firmware requesting an operating system to idle the processor module. The method further comprises the operating system idling the processor module and returning control of the processor module to the firmware.

According to one embodiment, a system comprises an Advanced Configuration and Power Interface (ACPI) compatible operating system. The system further comprises a processor module operating in lockstep mode, and system firmware operable, responsive to detection of loss of lockstep (LOL) for the processor module, to use an ACPI method to cause the operating system to idle the processor module.

### BRIEF DESCRIPTION OF THE DRAWINGS

FIG. 1 shows an exemplary system according to one embodiment in which system firmware and an operating system interact to reestablish lockstep on a processor module responsive to detecting a loss of lockstep (LOL) for the processor module;

FIG. 2 shows a block diagram of one embodiment implemented for the IA-64 processor architecture; and

FIG. 3 shows an exemplary operational flow diagram according to one embodiment.

### DETAILED DESCRIPTION OF THE INVENTION

As described further herein and in concurrently filed and commonly assigned U.S. patent application Ser. No. ______ [Attorney Docket No. 200404941-1] titled “SYSTEM AND METHOD FOR PROVIDING FIRMWARE RECOVERABLE LOCKSTEP PROTECTION,” the disclosure of which is incorporated herein by reference, certain techniques are provided for recovering from LOL detected for a processor module in a multi-processor system. In using these exemplary techniques, system firmware instructs the system's OS to idle the processor module for which LOL was detected. Control of the processor module is then returned to the system firmware so that the system firmware can take actions to attempt to recover the lockstep. If lockstep is successfully recovered, in certain implementations, the firmware triggers the OS to again recognize the processor module and begin scheduling instructions for it.

Exemplary techniques for instructing the OS to idle a processor module in response to detection of LOL for the processor module are described in concurrently filed and commonly assigned U.S. patent application Ser. No. ______ [Attorney Docket No. 200404970-1] titled “SYSTEM AND METHOD FOR SYSTEM FIRMWARE CAUSING AN OPERATING SYSTEM TO IDLE A PROCESSOR”, the disclosure of which is hereby incorporated herein by reference. In certain embodiments, responsive to detecting LOL for a processor module, system firmware uses an ACPI method for instructing the OS to idle (or “eject”) the processor module.

Embodiments provided herein detail further responsive actions that can be taken for reestablishing lockstep for a processor module for which LOL is detected. Exemplary embodiments are provided in which system firmware and the operating system (OS) interact, responsive to detected LOL for a processor module, to reestablish lockstep for the processor module. In accordance with certain embodiments, the OS idles the processor module for which LOL is detected. Thus, for instance, actions by the OS in idling the processor module according to one embodiment is provided. Additionally, actions by the system firmware in attempting to reestablish the lockstep for the processor module (e.g., after it is idled by the OS) according to one embodiment is provided. The responsive actions described herein may, in certain embodiments, be taken responsive to the OS being instructed to idle (or “eject”) the processor module in the manner described in concurrently filed and commonly assigned U.S. patent application Ser. No. ______ [Attorney Docket No. 200404970-1] titled “SYSTEM AND METHOD FOR SYSTEM FIRMWARE CAUSING AN OPERATING SYSTEM TO IDLE A PROCESSOR”.

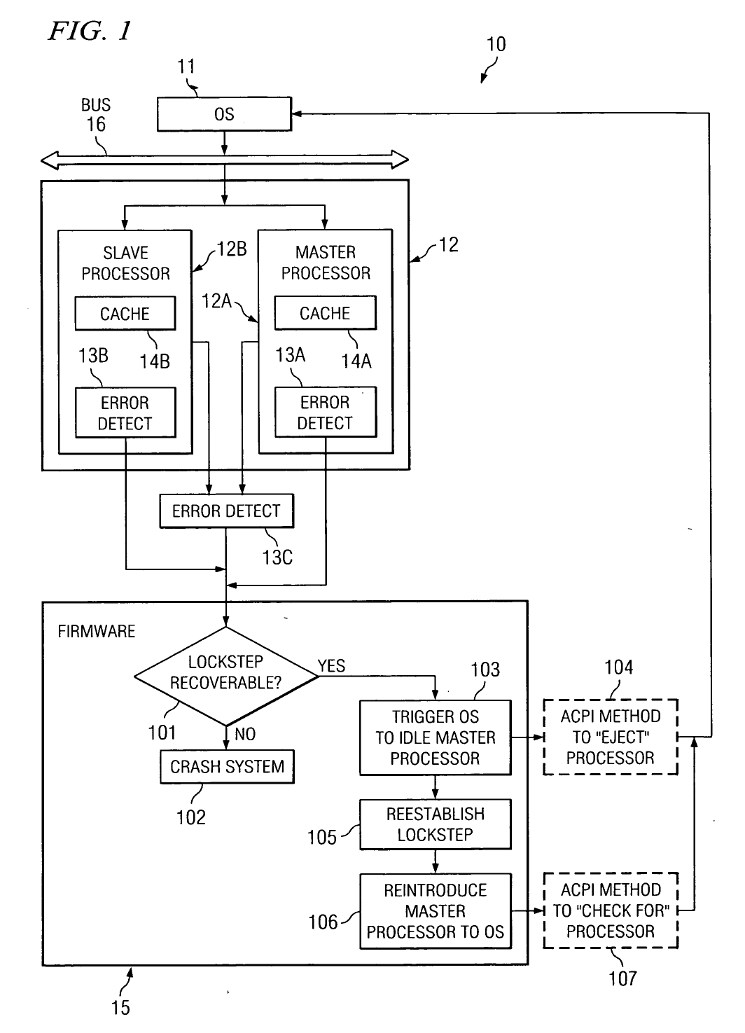

Turning to FIG. 1, an exemplary system 10 according to one embodiment is shown. System 10 includes OS 11, as well as master processor 12A and slave processor 12B (collectively referred to as a lockstep processor pair 12). In certain implementations the lockstep processor pair 12 may be implemented on a single silicon chip, which is referred to as a “dual core processor” in which master processor 12A is a first core and slave processor 12B is a second core. Further, lockstep processor pair 12 may be referred to as a processor or CPU “module” because it includes a plurality of processors (12A and 12B) in such module. Master processor 12A includes cache 14A, and slave processor 12B includes cache 14B. OS 11 and lockstep processor pair 12 are communicatively coupled to bus 16. Typically, master processor 12A and slave processor 12B are coupled to bus 16 via an interface that allows each of such processors to receive the same instructions to process, but such interface only communicates the output of master processor 12A back onto bus 16. The output of slave processor 12B is used solely for checking the output of mater processor 12A. While only one lockstep processor pair 12 is shown for simplicity in the example of FIG. 1, system 10 may include any number of such lockstep processor pairs. As one specific example, system 10 may have 64 lockstep processor pairs, wherein the master processors of the pairs may perform parallel processing for the system.

In this example, master processor 12A includes error detect logic 13A, and slave processor 12B includes error detect logic 13B. While shown as included in each of the processors 12A and 12B in this example, in certain embodiments the error detect logic 13A and 13B may be implemented external to processors 12A and 12B. Error detect logic 13A and 13B include logic for detecting errors, such as data cache errors, present in their respective processors 12A and 12B. Examples of error detect logic 13A and 13B include known parity-based mechanisms and ECC mechanisms. Error detect logic 13C is also included, which may include an XOR (exclusive OR) gate, for detecting a lockstep mismatch between master processor 12A and slave processor 12B. As mentioned above, a lockstep mismatch refers to the output of master processor 12A and slave processor 12B failing to match. While shown as external to the lockstep processor pair 12 in this example, in certain embodiments error detect logic 13C may be implemented on a common silicon chip with processors 12A and 12B.

Lockstep mismatch is one way of detecting a LOL between the master processor 12A and slave processor 12B. A detection of an error by either of error detect logic 13A and 13B also provides detection of LOL in the processors 12A and 12B. Because the detection of LOL by error detect logic 13A and 13B may occur before an actual lockstep mismatch occurs, the detection of LOL by error detect logic 13A and 13B may be referred to as a detection of a “precursor to lockstep mismatch”. In other words, once an error (e.g., corrupt data) is detected by error detect logic 13A or 13B, such error may eventually propagate to a lockstep mismatch error that is detectable by error detect logic 13C.

Firmware 15 is also included in system 10, which in this embodiment is invoked upon an error being detected by any of the error detect logics 13A, 13B, and 13C. In certain embodiments, processors 12A and 12B are processors from the Itanium Processor Family (IPF). IPF is a 64-bit processor architecture co-developed by Hewlett-Packard Company and Intel Corporation, which is based on Explicitly Parallel Instruction Computing (EPIC). IPF is a well-known family of processors. IPF includes processors such as those having the code names of MERCED, MCKINLEY, and MADISON. In addition to supporting a 64-bit processor bus and a set of 128 registers, the 64-bit design of IPF allows access to a very large memory (VLM) and exploits features in EPIC. While a specific example implementation of one embodiment is described below for the IPF architecture, embodiments for idling a processor in response to a detected LOL as described herein are not limited in application to an IPF architecture, but may be applied as well to other architectures (e.g., 32-bit processor architectures, etc.).

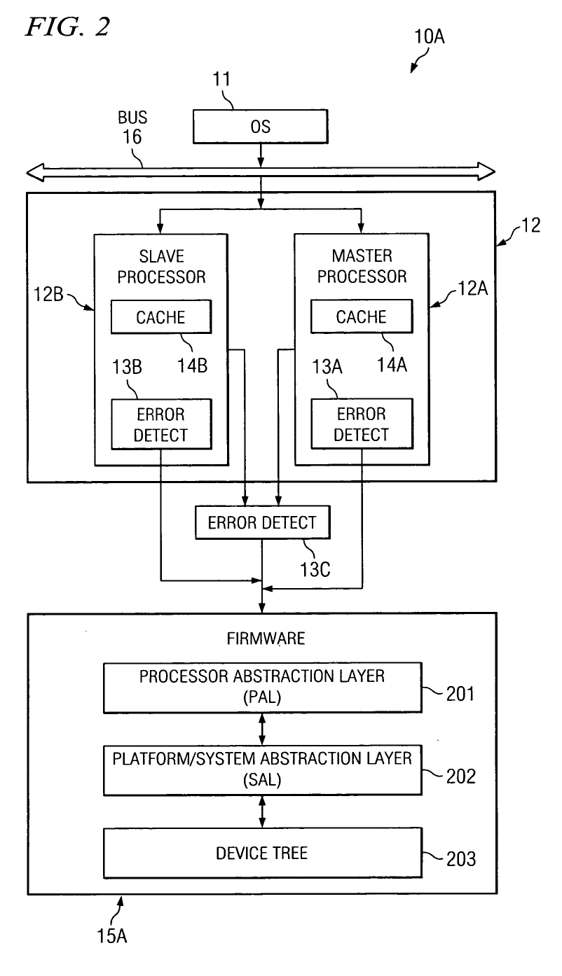

Processor architecture generally comprises corresponding supporting firmware, such as firmware 15 of system 10. For example, as described further below in conjunction with the specific example of FIG. 2, the IPF processor architecture comprises such supporting firmware as Processor Abstraction Layer (PAL), System Abstraction Layer (SAL), and Extended Firmware Interface (EFI). Such supporting firmware may enable, for example, the OS to access a particular function implemented for the processor. For instance, the OS may query the PAL as to the size of the cache implemented for the processor, etc. Other well-known functions provided by the supporting firmware (SAL, EFI) include, for example: (a) performing I/O configuration accesses to discover and program the I/O Hardware (SAL_PCI_CONFIG_READ and SAL_PCI_CONFIG_WRITE); (b) retrieving error log data from the platform following a Machine Check Abort (MCA) event (SAL_ET_STATE_INFO); (c) accessing persistent store configuration data stored in non-volatile memory (EFI variable services: GetNextVariableName, GetVariable and SetVariable); and accessing the battery-backed real-time clock/calendar (EFI GetTime and SetTime). Accordingly, the supporting firmware, such as the PAL, is implemented to provide an interface to the processor(s) for accessing the functionality provided by such processor(s). Each of those interfaces provide standard, published procedure calls that are supported. While shown as external to the lockstep processor pair 12 in this example, in certain embodiments all or a portion of firmware 15 may be implemented on a common silicon chip with processors 12A and 12B.

In the example embodiment of FIG. 1, upon firmware 15 being invoked responsive to detection of LOL for processor module 12 (by any of error detect logics 13A, 13B, and 13C), firmware 15 determines, in operational block 101, whether the detected LOL is a recoverable LOL. That is, firmware 15 determines in block 101 whether the detected LOL is of a type from which the firmware can recover lockstep for the lockstep processor pair 12 without crashing the system. If the lockstep is not recoverable from the detected LOL, then in the example of FIG. 1 firmware 15 crashes the system in block 102.

In this example, firmware 15 is implemented in a manner that allows for recovery from certain detected errors without requiring that OS 11 be implemented with specific knowledge for handling such recovery. However, if the lockstep is determined to be recoverable, firmware 15 cooperates with OS 11 via standard OS methods to recover the lockstep. For instance, in the example embodiment of FIG. 1, Advanced Configuration and Power Interface (ACPI) methods are used by firmware 15 to cooperate with OS 11. Accordingly, no processor or platform specific knowledge is required to be embedded in OS 11, but instead any ACPI-compatible OS may be used, including without limitation HP-UX and Open VMS operating systems.

In the example embodiment of FIG. 1, if lockstep is determined to be recoverable in block 101, then firmware 15 triggers OS 11 to idle the master processor 12A in block 103. In this embodiment, firmware 15 utilizes an ACPI method 104 to “eject” master processor 12A, thereby triggering OS 11 to idle the master processor 12A (i.e., stop scheduling tasks for the processor). Of course, by idling master processor 12A, slave processor 12B will in turn be idled. Thus, idling master processor 12A results in idling the lockstep processor pair 12. In this example embodiment, OS 11 is not aware of the presence of slave processor 12B, but is instead aware of master processor 12A. The interface of lockstep processor pair 12 to bus 16 manages copying to slave processor 12B the instructions that are directed by OS 11 to master processor 12A. Thus, firmware 15 need not direct OS 11 to eject slave processor 12B, as OS 11 is not aware of such slave processor 12B in this example implementation. Again, by idling master processor 12A, slave processor 12B is also idled as it merely receives copies of the instructions directed to master processor 12A. Of course, if in a given implementation OS 11 is aware of slave 12B, firmware 15 may be implemented to also direct OS 11 to idle such slave processor 12B in a manner similar to that described for idling master processor 12A.

Firmware 15 then attempts to recover lockstep for the lockstep processor pair 12 in block 105. For instance, firmware 15 resets the processor pair 12. During such reset of processor pair 12, system 10 can continue to operate on its remaining available processors (not shown in FIG. 1).

Once the processor pair 12 is reset and lockstep is recovered, firmware 15 reintroduces master processor 12A to OS 11 in operational block 106. In this embodiment, firmware 15 updates the ACPI device table information for master processor 12A to indicate that such master processor 12A is “present, functioning and enabled.” As discussed in the ACPI 2.0 specification for the _STA status method of a device, the _STA (status) object returns the status of a device, which can be one of the following: enabled, disabled, or removed. In this respect, in the result code (bitmap) bit 0 is set if the device is present; bit 1 is set if the device is enabled and decoding its resources; bit 2 is set if the device should be shown in the UI; bit 3 is set if the device is functioning properly (cleared if the device failed its diagnostics); bit 4 is set if the battery is present; and bits 5-31 are reserved. A device can only decode its hardware resources if both bits 0 and 1 are set. If the device is not present (bit 0 cleared) or not enabled (bit 1 cleared), then the device must not decode its resources. Bits 0, 1 and 3 are the “present, enabled and functioning” bits mentioned above. Firmware 15 utilizes an ACPI method 107 to trigger OS 11 to “check for” master processor 12A, thereby reintroducing the master processor 12A to OS 11. As a result of checking for master processor 12A, OS 11 will recognize that such master processor 12A is again available and will thus begin scheduling tasks for master processor 12A once again.

Exemplary techniques for recovering from a detected LOL that may be employed are described further in concurrently filed and commonly assigned U.S. patent application Ser. No. ______ [Attorney Docket No. 200404941-1] titled “SYSTEM AND METHOD FOR PROVIDING FIRMWARE RECOVERABLE LOCKSTEP PROTECTION,” the disclosure of which is incorporated herein by reference. Embodiments provided herein further discuss techniques for idling a processor module responsive to detection of LOL for such processor module. Embodiments provided herein do not require that the OS be implemented with processor-specific information to receive a request that the processor module be idled. That is, the OS is not required to be developed specifically for a certain processor architecture in order to receive a request that the processor module be idled. For instance, in certain embodiments, standard OS methods, such as ACPI methods, are used for such request. Thus, in certain embodiments, any ACPI-compatible OS can receive a request to idle a processor module for which LOL is detected, and responsive to such request the OS can idle the processor module in the manner described herein. Further, in certain embodiments, the OS passes control of the idled processor to the system firmware, and techniques are described further herein for the system firmware taking action to attempt to recover lockstep for the processor.

FIG. 2 shows a block diagram of one embodiment of the above system 10, which is implemented for the IPF processor architecture and is labeled as system 10_{A}. The quintessential model of the traditional IPF architecture is given in the Intel IA-64 Architecture Software Developer's Manual, Volume 2: IA-64 System Architecture, in section 11.1 Firmware Model, the disclosure of which is hereby incorporated herein by reference. Accordingly, in this example embodiment of system 10_{A}, firmware 15, labeled as firmware 15_{A}, includes processor abstraction layer (PAL) 201 and platform/system abstraction layer (SAL) 202. In general, PAL 201 is firmware provided by Intel for its processors, and SAL 202 is developed by an original equipment manufacturer (OEM) for the specific system/platform in which the processors are to be employed. PAL 201, SAL 202, as well as an extended firmware interface (EFI) layer (not shown), together provide, among other things, the processor and system initialization for an OS boot in an IPF system.

It should be noted that while the above description of PAL and SAL is specific to the IPF architecture, other architectures may include a “PAL” and “SAL” even though such firmware layers may not be so named or specifically identified as separate layers. In general, such a PAL layer may be included in a given system architecture to provide an interface to the processor hardware. The interface provided by the PAL layer is generally dictated by the processor manufacturer. Similarly, a SAL layer may be included in a given system architecture to provide an interface from the operating system to the hardware. That is, the SAL may be a system-specific interface for enabling the remainder of the system (e.g., OS, etc.) to interact with the non-processor hardware on the system and in some cases be an intermediary for the PAL interface.

The boot-up process of a traditional IPF system, for example, proceeds as follows: When the system is first powered on, there are some sanity checks (e.g., power on self-test) that are performed by microprocessors included in the system platform, which are not the main system processors that run applications. After those checks have passed, power and clocks are given to a boot processor (which may, for example, be master processor 12A). The boot processor begins executing code out of the system's Read-Only Memory (ROM) (not specifically shown in FIG. 2). The code that executes is the PAL 201, which gets control of system 10. PAL 201 executes to acquire all of the processors in system 10_{A} (recall that there may be many lockstep processor pairs 12) such that the processors begin executing concurrently through the same firmware.

After it has performed its duty of initializing the processor(s), PAL 201 passes control of system 10_{A} to SAL 202. It is the responsibility of SAL 202 to discover what hardware is present on the system platform, and initialize it to make it available for the OS 11. When main memory is initialized and functional, the firmware 15_{A} is copied into the main memory. Then, control is passed to EFI (not shown), which is responsible for activating boot devices, which typically includes the disk. The EFI reads the disk to load a program into memory, typically referred to as an operating system loader. The EFI loads the OS loader into memory, and then passes it control of system 10_{A} by branching the boot processor into the entry point of such OS loader program.

The OS loader program then uses the standard firmware interfaces to discover and initialize system 10_{A} further for control. One of the things that the OS loader typically has to do in a multi-processor system is to retrieve control of the other processors (those processors other than the boot processor). For instance, at this point in a multi-processor system, the other processors may be executing in do-nothing loops. In an ACPI-compatible system, OS 11 makes ACPI calls to parse the ACPI tables to discover the other processors of a multi-processor system in a manner as is well-known in the art. Then OS 11I uses the firmware interfaces to cause those discovered processors to branch into the operating system code. At that point, OS 11 controls all of the processors and the firmware 15_{A} is no longer in control of system 10_{A}.

As OS 11 is initializing, it has to discover from the firmware 15_{A} what hardware is present at boot time. And in the ACPI standards, it also discovers what hardware is present or added or removed at run-time. Further, the supporting firmware (PAL, SAL, and EFI) are also used during system runtime to support the processor. For example, OS 11 may access a particular function of master processor 12A via the supporting firmware 15_{A}, such as querying PAL 201 for the number, size, etc., of the processor's cache 14A. Some other well-known firmware functions that OS 11 may employ during runtime include: (a) PAL 201 may be invoked to configure or change processor features such as disabling transaction queuing (PAL_BUS_SET_FEATURES); (b) PAL 201 may be invoked to flush processor caches (PAL_CACHE_FLUSH); (c) SAL 202 may be invoked to retrieve error logs following a system error (SAL_GET_STATE_INFO, SAL_CLEAR_STATE_INFO); (d) SAL 202 may be invoked as part of hot-plug sequences in which new I/O cards are installed into the hardware (SAL_PCI_CONFIG_READ, SAL_PCI_CONFIG_WRIT); (e) EFI may be invoked to change the boot device path for the next time the system reboots (SetVariable); (f) EFI may be invoked to change the clock/calendar hardware settings; and (g) EFI may be invoked to shutdown the system (ResetSystem).

A “device tree” is provided, which is shown as device tree 203 in this example. Device tree 203 is stored in SRAM (Scratch RAM) on the cell, which is RAM that is reinitialized. Firmware 15A builds the device tree 203 as it discovers what hardware is installed in the system. Firmware then converts this information to the ACPI tables format and presents it to OS 11 so that OS 11 can know what is installed in the system. The ACPI device tables (not shown) are only consumed by OS 11 at boot time, so they are never updated as things change. For OS 11 to find the current status, it calls an ACPI “method” to discover the “current status”. The _STA method described above is an example of such an ACPI method. When _STA is called, the AML can look for properties on the device specified in the firmware device tree and convert that into the Result Code bitmap described above. So, if lockstep has been lost on a processor, firmware 15A will set the device tree property that indicates loss of lockstep, then when OS 11 calls _STA for that device, the “lockstep lost” property directs the AML code to return to “0” in the “functioning properly” bit so that OS 11 can know there is a problem with that processor.

A simple example of device tree 203 is shown below in Table 1:

TABLE 1

| | | Lockstep |
|---|---|---|
| Device | Status | Enabled |
| Processor A | Present, Enabled, and Functioning | Yes |

As mentioned above, once LOL is detected for a processor module, system firmware (e.g., SAL) may notify the OS that the processor module is to be idled (or “ejected”). Thus, it becomes desirable for the OS to idle the processor. Further, in certain embodiments, it is desirable to reestablish lockstep on the processor module. Exemplary embodiments are provided herein in which the OS idles a processor module for which LOL is detected, and actions are taken to attempt to reestablish lockstep for the processor module. Accordingly, certain embodiments disclosed herein provide techniques for reestablishing lockstep for a processor module for which LOL is detected.

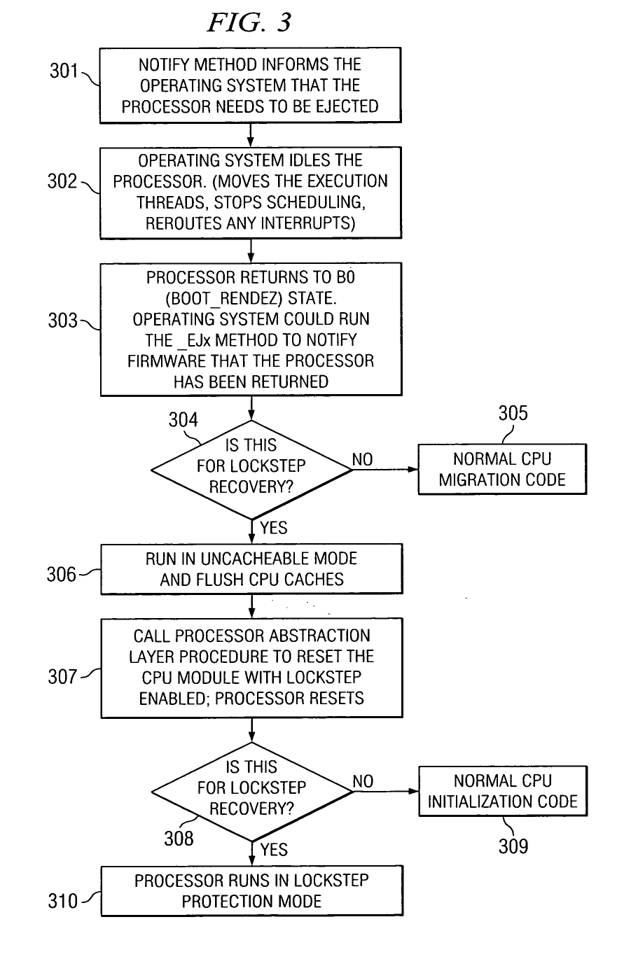

FIG. 3 shows an exemplary operational flow diagram of one embodiment. The operational flow diagram of FIG. 3 illustrates operation of one embodiment for attempting to reestablish lockstep on a processor module for which LOL is detected and lockstep is determined to be recoverable. That is, FIG. 3 shows an exemplary operational flow of one embodiment responsive to a determination in block 101 of FIG. 1 that lockstep is recoverable. As shown, in this example the OS is notified in operational block 301 by the system firmware that a processor module for which LOL has been detected is to be ejected. That is, in block 301, the OS receives a request from the system firmware to eject the processor module for which LOL was detected. Exemplary techniques that may be employed in block 301 for requesting the OS to eject a processor module are described further in concurrently filed and commonly assigned U.S. patent application Ser. No. ______ [Attorney Docket No. 200404970-1] titled “SYSTEM AND METHOD FOR SYSTEM FIRMWARE CAUSING AN OPERATING SYSTEM TO IDLE A PROCESSOR” the disclosure of which is hereby incorporated herein by reference. In certain embodiments, responsive to detecting LOL for a processor module, system firmware uses an ACPI method for instructing the OS to eject the processor module.

Once the OS knows that the processor module is to be ejected, the OS idles the processor module in operational block 302. In idling the processor module, the OS remaps any interrupts assigned to the processor, stops scheduling execution threads on that processor, and disassociates any resources that are allocated to that processor. In this embodiment, the OS has some time to perform these operations for idling the processor gracefully. The processor is no longer running with lockstep protection, but is otherwise fully functional. It should be recalled that system firmware determined in block 101 (of FIG. 1) that lockstep is recoverable. Thus, the only disability that the processor module has is that it has lost lockstep protection and is thus susceptible to a Silent Data Corruption problem, but these events are rare and the odds of this type of error occurring in the time (e.g., few minutes) it may take to idle the processor are extremely low.

Once the OS has idled the processor, in block 303 the processor returns to the branch location it came from when it was originally initialized (during boot-up) and its control was passed to the OS. For example, the processor module returns to branch register “B0] state, which is the state in which the processor was executing in a loop in firmware before being initially passed to the OS during the system's boot-up process. Thus, this returns control of the processor module to the system firmware. The OS could call the ACPI Eject method (the “_EJx” method) to inform the system firmware that the processor has been ejected, if desired. However, the firmware generally knows when the processor returns to firmware space as it is again executing instructions provided by the system firmware, and so using the Eject method to inform the system firmware in this manner may be omitted in certain implementations.

With the processor module for which LOL was detected now in firmware control, the firmware determines in block 304 why the processor module was returned to firmware. Particularly, the firmware determines whether the processor module was returned to firmware control for lockstep recovery. As described in concurrently filed and commonly assigned U.S. patent application Ser. No. ______ [Attorney Docket No. 200404970-1] titled “SYSTEM AND METHOD FOR SYSTEM FIRMWARE CAUSING AN OPERATING SYSTEM TO IDLE A PROCESSOR”, in certain embodiments the system firmware sets a property in the device tree before instructing the OS to idle the processor module (in block 301), wherein the property indicates that the processor module had a loss of lockstep. Thus, upon receiving control of the processor module after instructing the OS to idle the processor, the system firmware can examine the firmware device tree node associated with this processor module and determine if the property was set in such device tree indicating that the processor module had an LOL error. If there is an indication that this processor module had an LOL error, system firmware can assume that the processor module was ejected in order to have lockstep reestablished. If the LOL error is not indicated for the processor module in the device tree, system firmware can assume that the processor module was Ejected to firmware control for some other reason, in which case the system firmware defaults, in this example, to the normal “cpu migration” path in block 305 which means that the processor module is being migrated to a different partition. ACPI eject methods are commonly used for ejecting devices, such as PCI cards. In view of the above, in certain embodiments, the ACPI eject method is utilized to eject a processor module similar to ejecting PCI cards. Thus, the system OS is preferably implemented to recognize and respond to an ACPI eject method requested for a processor module (in a manner similar to ejecting a PCI card), rather than ignoring the eject method for such processor module.

If it is determined in block 304 that the processor module was ejected by the OS because of an LOL error, system firmware begins executing in uncachable mode in operational block 306 and flushes all of the processor module's caches. As is well-known in the art, when a processor reads data or instructions, the processor encaches it to improve performance in the future. If a difference processor needs to access the data that is in another processor's cache, it sends a message to that processor requesting that it flush the data so the second processor can use it. When a processor is reset, all of its caches become invalid. If the second processor were to request data that was in the recently reset processor's cache prior to the reset, the reset processor would no longer have that data to flush and cannot satisfy the request. This is generally referred to as “breaking coherency.” Therefore, before reset of an individual processor, it is generally desirable that there be no valid data in its cache. Running in unencacheable mode means accessing all data and instructions in a way that keeps them from being stored in the cache. Various processors have different ways of doing this. Additionally, all valid data can be obtained from the caches by flushing them, which is also a processor-dependent operation. Accordingly, in order to maintain system memory coherency, firmware runs in unencacheable mode and flushes all of the processor module's caches in operational block 306 in this example embodiment.

In operational block 307, a PAL call resets the processor module with the module's lockstep mode enabled. The processor module resets and comes up with lockstep reestablished. As PAL passes control to system firmware (SAL), system firmware determines, in block 308, whether this reset occurred because of a normal system reset or to reestablish lockstep. Again, the system firmware can access the device tree settings to determine if the firmware had previously set a property for this processor module indicating that an LOL was detected for the processor module. If determined that the reset is not to reestablish lockstep (e.g., the device tree does not indicate that an LOL had been detected for this processor module), normal CPU and system initialization occurs in operational block 309. If determined in block 308 that the reset is to reestablish lockstep, then in block 310 the processor vectors to a new path which will idle the processor until it can be reintroduced to the OS. Exemplary techniques for reintroducing the processor to the OS after lockstep is reestablished in this manner for the processor are described further in concurrently filed and commonly assigned U.S. patent application Ser. No. ______ [Attorney Docket No. 200404972-1] titled “SYSTEM AND METHOD FOR REINTRODUCING A PROCESSOR MODULE TO AN OPERATING SYSTEM AFTER LOCKSTEP RECOVERY,” the disclosure of which is hereby incorporated herein by reference.

The exemplary procedure provided in FIG. 3 reestablishes lockstep mode on a processor module that experienced an LOL error in accordance with one embodiment. While an exemplary operational flow is provided in FIG. 3, embodiments hereof are not limited to that illustrative example.

What is claimed is:

1. A method for reestablishing lockstep for a processor module for which loss of lockstep is detected, the method comprising:
an operating system idling a processor module for which loss of lockstep (LOL) is detected;
system firmware receiving control of the processor module;
system firmware determining whether a LOL was detected for the processor module; and
if determined that LOL was detected for the processor module, said system firmware resetting the processor module to reestablish lockstep for the processor module.

2. The method of claim 1 further comprising:
said operating system idling said processor module responsive to an Advanced Configuration and Power Interface (ACPI) eject method for said processor module.

3. The method of claim 1 further comprising:
said system firmware returning to the operating system control of the reset processor module having its lockstep reestablished.

4. The method of claim 1 wherein said idling the processor module comprises:
remapping any interrupts assigned to the processor module;
stop scheduling execution threads on the processor module; and
disassociating any resources that are allocated to the processor module.

5. The method of claim 1 wherein said lockstep is reestablished for the processor module without shutting down the operating system.

6. The method of claim 1 further comprising:
said operating system scheduling tasks for said processor module having its lockstep reestablished.

7. A method comprising:
detecting loss of lockstep for a lockstep pair of processors;
requesting, by system firmware, an operating system to idle the lockstep pair of processors; and
idling, by the operating system, the lockstep pair of processors.

8. The method of claim 7 wherein said requesting comprises:
causing an Advanced Configuration and Power Interface (ACPI) eject method to be executed for the lockstep pair of processors.

9. The method of claim 7 wherein said idling the lockstep pair of processors comprises:
remapping any interrupts assigned to the lockstep pair of processors;
stop scheduling execution threads on the lockstep pair of processors; and
disassociating any resources that are allocated to the lockstep pair of processors.

10. The method of claim 7 further comprising:
said system firmware reestablishing lockstep for the lockstep pair of processors.

11. The method of claim 10 wherein said reestablishing lockstep comprises:
resetting the lockstep pair of processors.

12. The method of claim 10 wherein said system firmware reestablishes lockstep for the lockstep pair of processors without shutting down the operating system.

13. The method of claim 10 further comprising:
said system firmware causing said operating system to recognize the lockstep pair of processors having lockstep reestablished as available for performing tasks.

14. A method comprising:
responsive to detection of loss of lockstep (LOL) for a processor module in a system, firmware requesting an operating system to idle the processor module; and
the operating system idling the processor module and returning control of the processor module to the firmware.

15. The method of claim 14 further comprising:
the firmware determining whether it was returned control of the processor module because of a detected LOL for the processor module.

16. The method of claim 15 wherein said determining comprises:
accessing information stored to non-volatile data storage.

17. The method of claim 16 wherein responsive to said detection of LOL for the processor module, said firmware stores information to said non-volatile data storage indicating that the processor module had an LOL.

18. The method of claim 14 further comprising:
said firmware reestablishing lockstep for the processor module.

19. The method of claim 18 wherein said reestablishing lockstep comprises:
resetting the processor module.

20. The method of claim 18 wherein said firmware reestablishes lockstep for the processor module without shutting down the operating system.

21. The method of claim 18 further comprising:
said firmware causing said operating system to recognize the processor module having lockstep reestablished as available for performing tasks.

22. The method of claim 14 wherein said firmware requesting an operating system to idle the processor module comprises:
said firmware causing an Advanced Configuration and Power Interface (ACPI) eject method to be executed for said processor module.

23. The method of claim 14 wherein said idling the processor module comprises:
remapping any interrupts assigned to the processor module;
stop scheduling execution threads on the processor module; and
disassociating any resources that are allocated to the processor module.

24. A system comprising:
an Advanced Configuration and Power Interface (ACPI) compatible operating system; processor module operating in lockstep mode; and
system firmware operable, responsive to detection of loss of lockstep (LOL) for the processor module, to use an ACPI method to cause said operating system to idle the processor module.

25. The system of claim 24 wherein said operating system is operable, responsive to said ACPI method, to idle the processor module and return control of the processor module to the system firmware.

26. The system of claim 24 wherein said ACPI method is an eject method.

27. The system of claim 24 wherein said processor module is an Itanium Processor Family (IPF) processor.
